(19) United States
(12) Patent Application Publication
(10) Pub. No.: US 2026/0286967 A1
(43) Pub. Date: Sep. 24, 2026

(54) CANNED MOTOR PUMP AND FUEL CELL COMPRISING THE SAME

(71) Applicant: ZHONGSHAN H2 FOREST TECHNOLOGY CO., LTD., Zhongshan (CN)

(72) Inventors: Xingyuan CHEN, Zhongshan (CN); Zhenqiang HUANG, Zhongshan (CN); Yunyan WANG, Zhongshan (CN)

(21) Appl. No.: 19/686,766

(22) Filed: May 24, 2026

Related U.S. Application Data
(63) Continuation-in-part of application No. PCT/CN2024/121358, filed on Sep. 26, 2024.

(30) Foreign Application Priority Data
Feb. 20, 2024 (CN) 202410187492.3

(51) Int. Cl. F04D 25/06; F04D 29/02; H01M 8/04082

(52) U.S. Cl. CPC F04D 25/0606; F04D 25/068; F04D 29/02; H01M 8/04082

(57) ABSTRACT

A canned motor pump including a pump housing assembly, an impeller, and a motor. The motor includes a motor housing assembly. The motor housing assembly includes a front end cover, a casing sleeve, and a rear end cover. A capacitor box is disposed on an outer sidewall of the casing sleeve near the front end cover. The capacitor box defines an accommodating cavity therein. A capacitor assembly is disposed in the accommodating cavity; an opening is disposed at the top end of the capacitor box, and the opening communicates with the accommodating cavity. The front end cover includes a metal inner cover and a plastic outer cover. Two pins are led out from the capacitor assembly; one pin is electrically connected to the casing sleeve, and the other pin is electrically connected to the metal inner cover of the front end cover.

### CROSS-REFERENCE TO RELATED APPLICATIONS

This application is a continuation-in-part of International Patent Application No. PCT/CN 2024/121358 with an international filing date of Sep. 26, 2024, designating the United States, now pending, further claims foreign priority benefits to Chinese Patent Application No. 202410187492.3 filed Feb. 20, 2024. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to a canned motor pump and a fuel cell comprising the same.

A water pump used for heat dissipation in a fuel cell is typically a canned motor pump. To achieve dielectric insulation, the front end cover of the pump is usually made of an insulating material such as plastic, so as to insulate the pump head from the high-voltage components of the motor and the electronic control system. However, in pumps designed with such a configuration, the front end cover, being made of plastic, cannot provide an effective shielding function. As a result, the pump often fails to meet the requirements for suppressing radiated emissions, and consequently cannot satisfy the electromagnetic compatibility (EMC) test requirements for the fuel cell system.

### SUMMARY

One objective of the disclosure is to provide a canned motor pump comprising a pump housing assembly, an impeller, and a motor. The motor comprises a motor housing assembly, a stator assembly, a rotor assembly, and a rotating shaft; the motor housing assembly comprises a front end cover, a casing sleeve, and a rear end cover; the front end cover and the rear end cover are respectively mounted at two ends of the casing sleeve; the stator assembly is fitted on an inner wall of the casing sleeve; the rotor assembly is fitted inside the stator assembly. The pump housing assembly comprises a volute and a cover plate; the cover plate is disposed on the front end cover; the volute is disposed on the cover plate to form a cavity; the volute comprises a water inlet and a water outlet, both communicating with the cavity; the impeller is disposed inside the cavity and connected to an extended end of the rotating shaft; the casing sleeve comprises a metal material; a capacitor box is disposed on an outer sidewall of the casing sleeve near the front end cover; the capacitor box defines an accommodating cavity therein; a capacitor assembly is disposed in the accommodating cavity; an opening is disposed at a top end of the capacitor box, and the opening communicates with the accommodating cavity; the front end cover comprises a metal inner cover and a plastic outer cover; the plastic outer cover is located between the cover plate and the metal inner cover; the plastic outer cover is used to cover the opening of the capacitor box; two pins are led out from the capacitor assembly; one pin is electrically connected to the casing sleeve, and the other pin is electrically connected to the metal inner cover of the front end cover.

In a class of this embodiment, the capacitor assembly comprises a Y capacitor, a circuit board, and a metal elastic piece; the Y capacitor is fixedly disposed on a bottom surface of the circuit board; the metal elastic piece is fixedly disposed on a top surface of the circuit board; an end of the metal elastic piece extends out of the opening of the capacitor box; and when the front end cover is disposed on the casing sleeve, the metal inner cover of the front end cover compresses the metal elastic piece and is electrically connected thereto.

In a class of this embodiment, two mounting bosses for fixing the circuit board are respectively disposed on two sides of the accommodating cavity; each mounting boss is provided with a first mounting hole; the circuit board is provided with second mounting holes corresponding to the first mounting holes; and screws are passed through the second mounting holes and connected to the first mounting holes, thereby fixing the circuit board onto the mounting bosses.

In a class of this embodiment, the Y capacitor is fixedly soldered onto the circuit board; the circuit board is then fixed inside the capacitor box by two screws; one pin of the Y capacitor is electrically connected to the casing sleeve via the circuit board and the screws; and the other pin of the Y capacitor is electrically connected to the metal inner cover of the front end cover via the circuit board and the metal elastic piece.

In a class of this embodiment, after installation, the metal elastic piece protrudes beyond an end surface of the casing sleeve by a range of 1 mm to 5 mm; and after the front end cover is installed, the front end cover compresses the metal elastic piece, causing the metal elastic piece and the Y capacitor to be electrically connected to the metal inner cover of the front end cover.

In a class of this embodiment, the front end cover further comprises an insulating sleeve; and the insulating sleeve is disposed at an inner edge of the capacitor box between the capacitor box and the metal inner cover.

In a class of this embodiment, the motor further comprises a shielding sleeve; the shielding sleeve is fitted inside the stator assembly; the rotor assembly is disposed in a shielding cavity of the shielding sleeve; the shielding sleeve isolates the stator assembly from the rotor assembly; and a bottom end of the shielding sleeve abuts against a surface of the rear end cover.

In a class of this embodiment, a controller is disposed at a bottom of the rear end cover.

In a class of this embodiment, the casing sleeve comprises an aluminum alloy material, the metal inner cover of the front end cover comprises an aluminum alloy material, and the volute comprises a plastic material.

In another aspect, the disclosure provides a fuel cell, comprising: a stack module, a hydrogen supply system, an air supply system, and a cooling system; and the cooling system comprises the aforesaid canned motor pump.

The following advantages are associated with the canned motor pump and a fuel cell comprising the same. The structural arrangement of the canned motor pump meets the dielectric insulation requirement, ensuring physical isolation and insulation between the medium and high-voltage components; at the same time, the configuration achieves the shielding requirement for radiated emission signals of the pump system, thereby enabling the pump to satisfy EMC test requirements.

### BRIEF DESCRIPTION OF THE DRAWINGS

FIG. 1 is a perspective view of a canned motor pump of the disclosure;

FIG. 2 is an exploded view of a canned motor pump of the disclosure;

FIG. 3 is an exploded view of a motor of a canned motor pump of the disclosure;

FIG. 4 is a partial exploded view of a motor of a canned motor pump of the disclosure, showing the arrangement of a capacitor assembly and a capacitor box of the motor;

FIG. 5 is a front view of a canned motor pump of the disclosure;

FIG. 6 is a cross-sectional view taken along line A-A of FIG. 5; and

FIG. 7 is an enlarged view of part B of FIG. 6.

### DETAILED DESCRIPTION

To further illustrate the disclosure, embodiments detailing a canned motor pump and a fuel cell comprising the same are described below. It should be noted that the following embodiments are intended to describe and not to limit the disclosure.

### Example 1

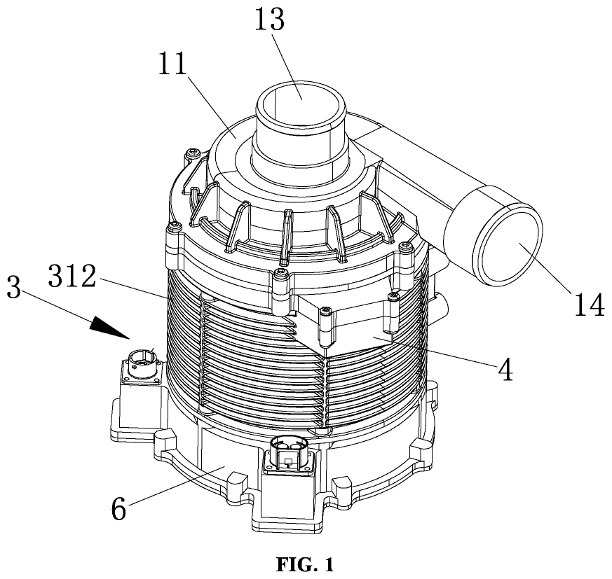

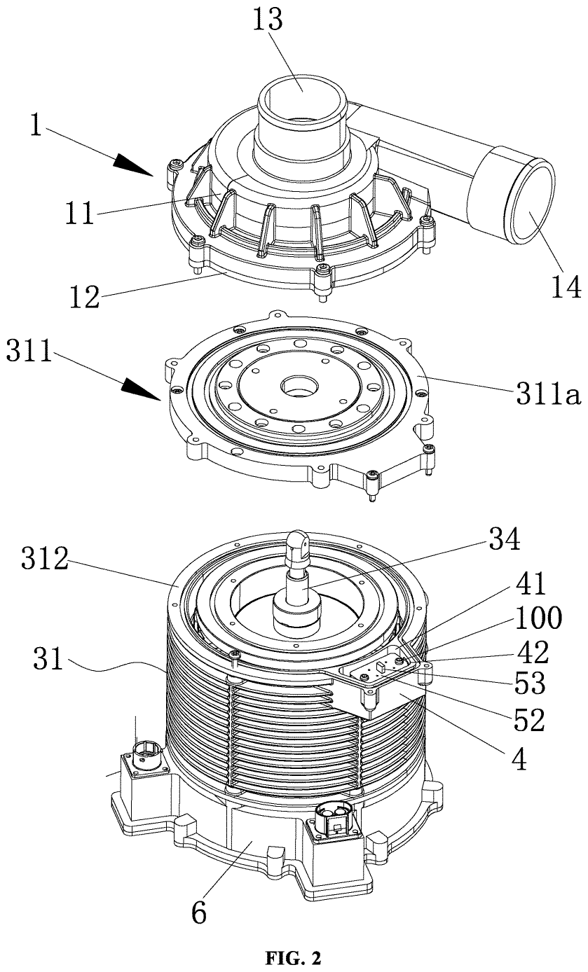

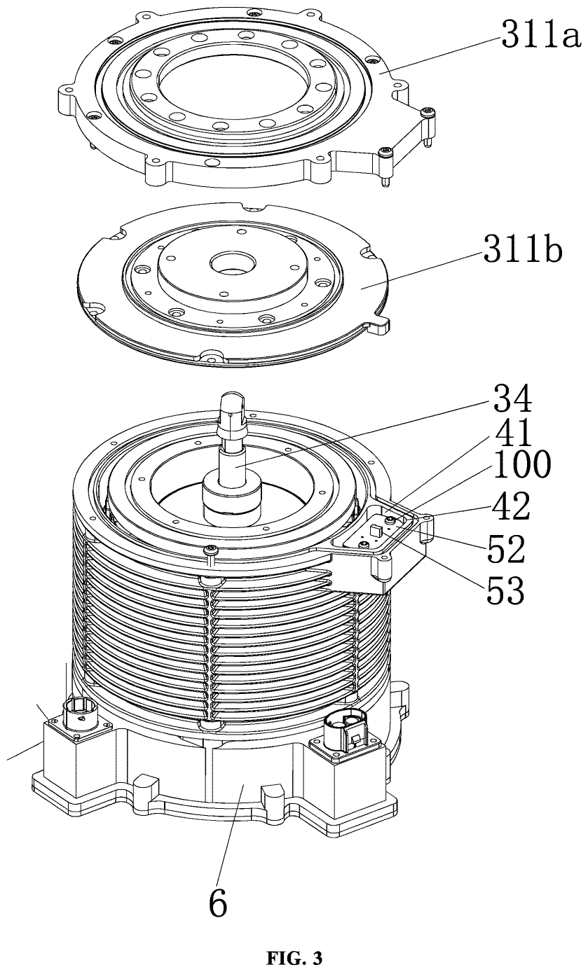

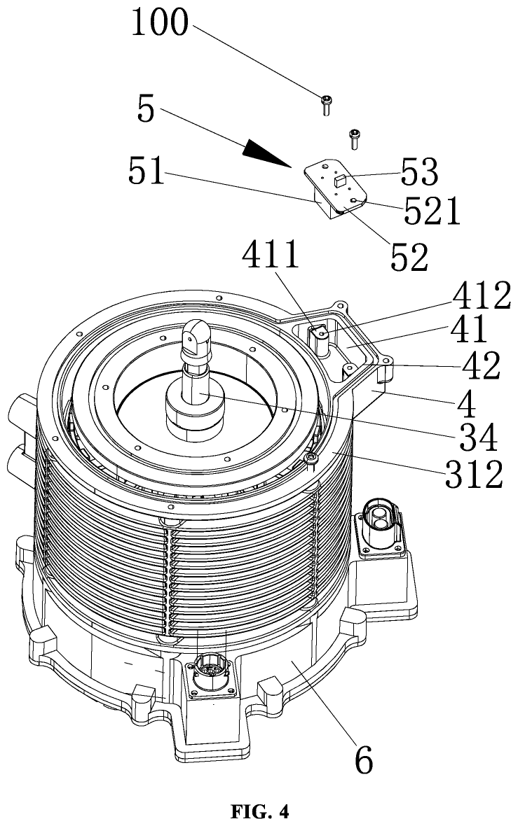

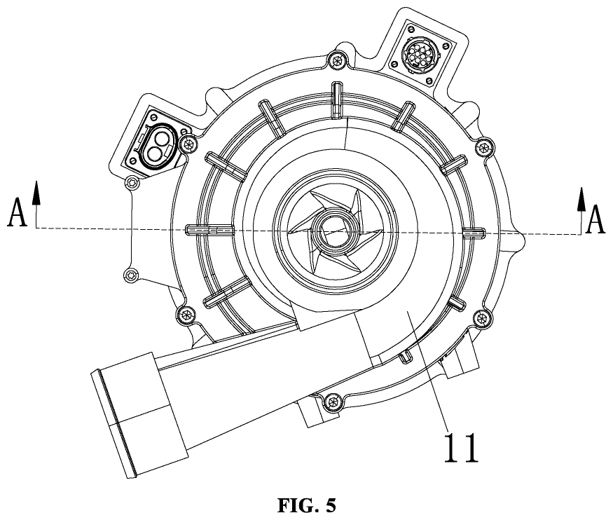

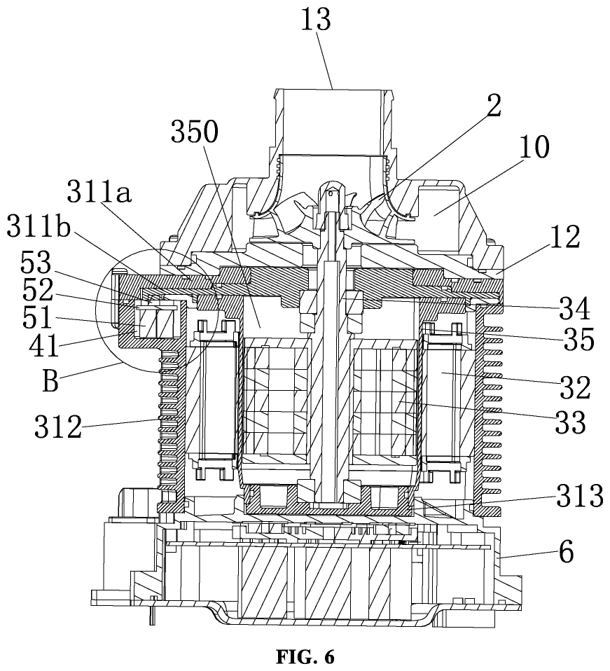

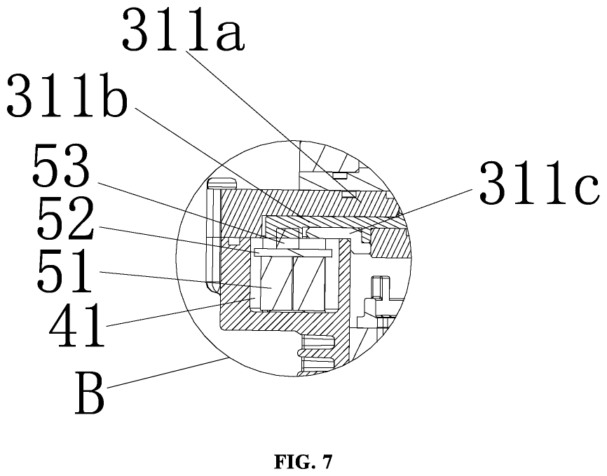

As shown in FIGS. 1 to 7, this example provides a canned motor pump, comprising a pump housing assembly 1, an impeller 2, and a motor 3.

The motor 3 comprises a motor housing assembly 31, a stator assembly 32, a rotor assembly 33, and a rotating shaft 34. The motor housing assembly 31 comprises a front end cover 311, a casing sleeve 312, and a rear end cover 313. The front end cover 311 and the rear end cover 313 are respectively mounted at two ends of the casing sleeve 312. The stator assembly 32 is fitted on an inner wall of the casing sleeve 312. The rotor assembly 33 is fitted inside the stator assembly 32.

The pump housing assembly 1 comprises a volute 11 and a cover plate 12. The cover plate 12 is disposed on the front end cover 311. The volute 11 is disposed on the cover plate 12 to form a cavity 10. The volute 11 comprises a water inlet 13 and a water outlet 14, both communicating with the cavity 10. The impeller 2 is disposed inside the cavity 10 and connected to an extended end of the rotating shaft 34.

The casing sleeve 312 comprises a metal material. A capacitor box 4 is disposed on an outer sidewall of the casing sleeve 312 near the front end cover. The capacitor box 4 defines an accommodating cavity 41 therein. A capacitor assembly 5 is disposed in the accommodating cavity 41. An opening 42 is disposed at a top end of the capacitor box 4, and the opening 42 communicates with the accommodating cavity 41. The front end cover 311 comprises a metal inner cover 311b and a plastic outer cover 311a. The plastic outer cover 311a is located between the cover plate 12 and the metal inner cover 311b, and is used to cover the opening 42 of the capacitor box 4. Two pins are led out from the capacitor assembly 5; one pin is electrically connected to the casing sleeve 312, and the other pin is electrically connected to the metal inner cover 311b of the front end cover 311. This structural arrangement meets the dielectric insulation requirement of the canned motor pump, ensuring physical isolation and insulation between the medium and high-voltage components. At the same time, the arrangement achieves the shielding requirement for radiated emission signals of the pump system, ensuring that the pump can pass the EMC test requirements.

The capacitor assembly 5 comprises a Y capacitor 51, a circuit board 52, and a metal elastic piece 53. The Y capacitor 51 is fixedly disposed on a bottom surface of the circuit board 52. The metal elastic piece 53 is fixedly disposed on a top surface of the circuit board 52. An end of the metal elastic piece 53 extends out of the opening 42 of the capacitor box 4. When the front end cover 311 is disposed on the casing sleeve 312, the metal inner cover 311b of the front end cover 311 compresses the metal elastic piece 53 and is electrically connected therewith. The structural arrangement of the metal elastic piece 53 ensures electrical connection and conduction with the metal inner cover 311b of the front end cover 311, thereby ensuring that the pump can pass the EMC test requirements.

Two mounting bosses 411 for fixing the circuit board 52 are respectively disposed on two sides of the accommodating cavity 41. Each mounting boss 411 is provided with a first mounting hole 412. The circuit board 52 is provided with second mounting holes 521 corresponding to the first mounting holes 412. Screws 100 are passed through the second mounting holes 521 and connected to the first mounting holes 412, thereby fixing the circuit board 52 onto the mounting bosses 411.

The Y capacitor 51 is fixedly soldered onto the circuit board 52. The circuit board 52 is then fixed inside the capacitor box 4 by two screws 100. One pin of the Y capacitor 51 is electrically connected to the casing sleeve 312 via the circuit board 52 and the screws 100. The other pin of the Y capacitor 51 is electrically connected to the metal inner cover 311b of the front end cover 311 via the circuit board 52 and the metal elastic piece 53.

After installation, the metal elastic piece 53 protrudes beyond an end surface of the casing sleeve 312 by a range of 1 mm to 5 mm. After the front end cover 311 is installed, it compresses the metal elastic piece 53, causing the metal elastic piece 53 and the Y capacitor 51 to be electrically connected to the metal inner cover 311b of the front end cover 311, thereby ensuring that the pump can pass the EMC test requirements.

The front end cover 311 further comprises an insulating sleeve 311c. The insulating sleeve 311c is disposed at an inner edge of the capacitor box 4 between the capacitor box 4 and the metal inner cover 311b.

The motor 3 further comprises a shielding sleeve 35. The shielding sleeve 35 is fitted inside the stator assembly 32. The rotor assembly 33 is disposed in a shielding cavity 350 of the shielding sleeve 35. The shielding sleeve 35 isolates the stator assembly 32 from the rotor assembly 33. A bottom end of the shielding sleeve 35 abuts against a surface of the rear end cover 313.

A controller 6 is disposed at a bottom of the rear end cover 313.

The casing sleeve 312 comprises an aluminum alloy material. The metal inner cover 311b of the front end cover 311 comprises an aluminum alloy material. The volute 11 comprises a plastic material. This configuration meets the dielectric insulation requirement of the canned motor pump, ensuring physical isolation and insulation between the medium and high-voltage components. At the same time, the configuration achieves the shielding requirement for radiated emission signals of the pump system, thereby enabling the pump to satisfy EMC test requirements.

### Example 2

A fuel cell comprises a stack module, a hydrogen supply system, an air supply system, and a cooling system; the cooling system comprises the canned motor pump of Example 1.

It will be obvious to those skilled in the art that changes and modifications may be made, and therefore, the aim in the appended claims is to cover all such changes and modifications.

What is claimed is:

1. A canned motor pump, comprising:
a pump housing assembly, the pump housing assembly comprising a volute and a cover plate;
an impeller; and
a motor, the motor comprising a motor housing assembly, a stator assembly, a rotor assembly, and a rotating shaft;
wherein:
the motor housing assembly comprises a front end cover, a casing sleeve, and a rear end cover; the front end cover and the rear end cover are respectively mounted at two ends of the casing sleeve; the stator assembly is fitted on an inner wall of the casing sleeve; the rotor assembly is fitted inside the stator assembly;
the cover plate is disposed on the front end cover; the volute is disposed on the cover plate to form a cavity; the volute comprises a water inlet and a water outlet, both communicating with the cavity; the impeller is disposed inside the cavity and connected to an extended end of the rotating shaft;
the casing sleeve comprises a metal material; a capacitor box is disposed on an outer sidewall of the casing sleeve near the front end cover; the capacitor box defines an accommodating cavity therein; a capacitor assembly is disposed in the accommodating cavity; an opening is disposed at a top end of the capacitor box, and the opening communicates with the accommodating cavity; the front end cover comprises a metal inner cover and a plastic outer cover; the plastic outer cover is located between the cover plate and the metal inner cover; the plastic outer cover is used to cover the opening of the capacitor box; two pins are led out from the capacitor assembly; one pin is electrically connected to the casing sleeve, and the other pin is electrically connected to the metal inner cover of the front end cover.

2. The canned motor pump of claim 1, wherein the capacitor assembly comprises a Y capacitor, a circuit board, and a metal elastic piece; the Y capacitor is fixedly disposed on a bottom surface of the circuit board; the metal elastic piece is fixedly disposed on a top surface of the circuit board; an end of the metal elastic piece extends out of the opening of the capacitor box; and when the front end cover is disposed on the casing sleeve, the metal inner cover of the front end cover compresses the metal elastic piece and is electrically connected thereto.

3. The canned motor pump of claim 2, wherein two mounting bosses for fixing the circuit board are respectively disposed on two sides of the accommodating cavity; each mounting boss is provided with a first mounting hole; the circuit board is provided with second mounting holes corresponding to the first mounting holes; and screws are passed through the second mounting holes and connected to the first mounting holes, thereby fixing the circuit board onto the mounting bosses.

4. The canned motor pump of claim 3, wherein the Y capacitor is fixedly soldered onto the circuit board; the circuit board is then fixed inside the capacitor box by two screws; one pin of the Y capacitor is electrically connected to the casing sleeve via the circuit board and the screws; and the other pin of the Y capacitor is electrically connected to the metal inner cover of the front end cover via the circuit board and the metal elastic piece.

5. The canned motor pump of claim 4, wherein after installation, the metal elastic piece protrudes beyond an end surface of the casing sleeve by a range of 1 mm to 5 mm; and after the front end cover is installed, the front end cover compresses the metal elastic piece, causing the metal elastic piece and the Y capacitor to be electrically connected to the metal inner cover of the front end cover.

6. The canned motor pump of claim 5, wherein the front end cover further comprises an insulating sleeve; and the insulating sleeve is disposed at an inner edge of the capacitor box between the capacitor box and the metal inner cover.

7. The canned motor pump of claim 1, wherein the motor further comprises a shielding sleeve; the shielding sleeve is fitted inside the stator assembly; the rotor assembly is disposed in a shielding cavity of the shielding sleeve; the shielding sleeve isolates the stator assembly from the rotor assembly; and a bottom end of the shielding sleeve abuts against a surface of the rear end cover.

8. The canned motor pump of claim 7, wherein a controller is disposed at a bottom of the rear end cover.

9. The canned motor pump of claim 8, wherein the casing sleeve comprises an aluminum alloy material, the metal inner cover of the front end cover comprises an aluminum alloy material, and the volute comprises a plastic material.

10. A fuel cell, comprising: a stack module, a hydrogen supply system, an air supply system, and a cooling system; wherein the cooling system comprises the canned motor pump of claim 1.
